(19) United States
(12) Patent Application Publication
(10) Pub. No.: US 2007/0179884 A1
(43) Pub. Date: Aug. 2, 2007

(54) Democracy of donations

(76) Inventor: Brendon Hewlett, Parramatta (AU)

Correspondence Address: KENNETH M. FAGIN, 136 SUMMER WALK DRIVE, GAITHERSBURG, MD, 20878, US

(21) Appl. No.: 11/650,552

(22) Filed: Jan. 8, 2007

(30) Foreign Application Priority Data
Feb. 1, 2006 (AU) 2006900461
Dec. 21, 2006 (AU) 2006252183

(51) Int. Cl. G06Q 40/00

(52) U.S. Cl. 705/39

(57) ABSTRACT

The invention concerns paying donations, and in particular, donations paid by a business entity 14 based on sales. An administrator 18 of the democratic donations system receives and stores information on purchases made from a business entity that each have an associated donation. The administrator 18 then receives purchase information from a customer 16 and the name of the beneficiary that they would like the donation associated with the purchase paid to. The administrator 18 cross-matches the purchase information and if a match is found adds the donation associated with the purchase to the total donation amount to be paid to that beneficiary by the business entity 16. Then at periodic intervals the administrator 18 sends to the business entity 16 the total donation amount to be paid to each beneficiary by the business entity 16 and allows the beneficiary and customer to know the details of the donation thus confirmed. Other aspects of the invention includes a computer system and software for managing donations.

### CROSS-REFERENCE TO RELATED APPLICATIONS

The present application claims priority from Australian Provisional Patent Application No 2006900461 filed on 1 Feb. 2006, the content of which is incorporated herein by reference.

### TECHNICAL FIELD

The invention concerns paying donations, and in particular, donations paid by a business entity based on sales. Aspects of the invention includes a method, computer system and software for managing donations.

### BACKGROUND ART

Donations from business entities to various non-profit organisations are often based on purchases of goods or services from the business by a customer. These are often advertised as “a percentage of each sale will go to X”, where X is the name of a particular non-profit organisation.

However, the choice of the charity X by the business organisation is skewed to the business' prerogatives, vested political, ideological or commercial/administrative interests. Further the choice of non-profit organisation can be inconsistent, selected in an ad-hoc manner as the circumstances change and usually to only a few large and expensively run non-profit organisations that have high profiles.

### SUMMARY OF THE INVENTION

In a first aspect the invention concerns a method of managing donations, wherein the method comprises the steps of:
receiving and storing information on a plurality of purchases from a business entity, wherein each purchase has an associated donation;
receiving information of purchases made from the business entity by customers and an indication of the beneficiary that the associated donation should be paid to;
cross-matching the information on purchases made from business entities and information on purchases made by customers;
if a match is found for a purchase, adding the donation associated with the purchase to the total donation amount to be paid to that beneficiary by the business entity;
sending to the business entity the total donation amount to be paid to each beneficiary by the business entity.

It is an advantage of the system that customers can determine which beneficiary the donation that is associated with their purchase will be paid to. This enables donations to flow directly to beneficiaries that need it most in the opinion of the customers, rather than the business entities. In this way a culture of giving and caring is promoted, rather than cynicism often generated with the donation methods of the prior art. It is a further advantage that the donations payable are collated reducing the administrative burden of paying many small donations to different beneficiaries.

A purchase may be a retail purchase of a good or service. The beneficiary may be a non-profit organisation.

The associated donation may be based on the total price of the purchase or based on one or more of the items included in the purchase. The method may further comprise the step of determining the amount of the donation for the purchase.

If a match is found the method may further comprise not using the matched purchase in any future cross-matching steps.

The step of receiving information on purchases made by customers may comprise receiving the information as entered into on a website.

The method may further comprise the step of determining whether the beneficiary that the donation to be paid to is a suitable beneficiary.

The method may further comprise the step of resetting the total donation amount to be paid to all beneficiaries by the business organisation at a predetermined time interval.

The step of sending the business entity the total donation amount may only be performed at a predetermined time interval.

The method may further comprise receiving and storing details of the customer, and sending this information to the business entity together with the total donation amount to be paid.

The invention further concerns a computer system to manage donations, computer system comprising:
a purchase storage means to store information on a plurality of purchases from a business entity, wherein each purchase has an associated donation; and information of purchases made from the business entity by customers and an indication of the beneficiary that the associated donation should be paid to;
a processor to cross-match the information on purchases from a business entity and purchases made by customers, and if a match is found for a purchase, the processor operates to add the donation associated with the purchase to the total donation amount to be paid to that beneficiary by the business entity.

The processor may further operate to determine the total donation amount to be paid to each beneficiary by the business entity.

The computer system may be connected to the Internet. The computer system may further comprise a communication port to send to the business entity the total donation amount to be paid to each beneficiary by the business entity.

The same or different communication port may be used to receive the information about the purchases.

In yet a further aspect the invention provides software, that when stored on a computer readable storage means medium, causes the computer to operate in accordance with the method described above.

The ultimate goal is to foster a culture of compassion and giving amongst consumers, and engage a fully accountable and measurable system of fostering corporate social responsibility—one that is driven by the public for the public. It facilitates a mechanism of accountability and feedback to ensure the donations are made as requested, on a regular basis and as an integral part of the business' daily activity. It allows business entities to engage their customers in a more meaningful way; ensuring regular, positive brand exposure and improved public relations.

### BRIEF DESCRIPTION OF THE DRAWINGS

An example of the invention will now be described with reference to the accompanying drawings, in which:

FIG. 1 is a schematic diagram of the computer system of the invention; and

FIG. 2 is a flow chart of the method of the invention.

### BEST MODES OF THE INVENTION

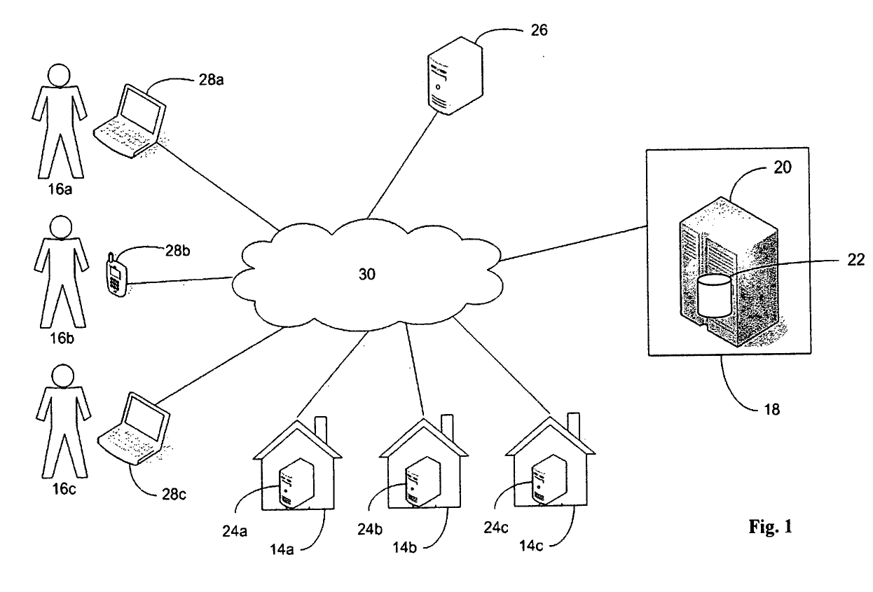

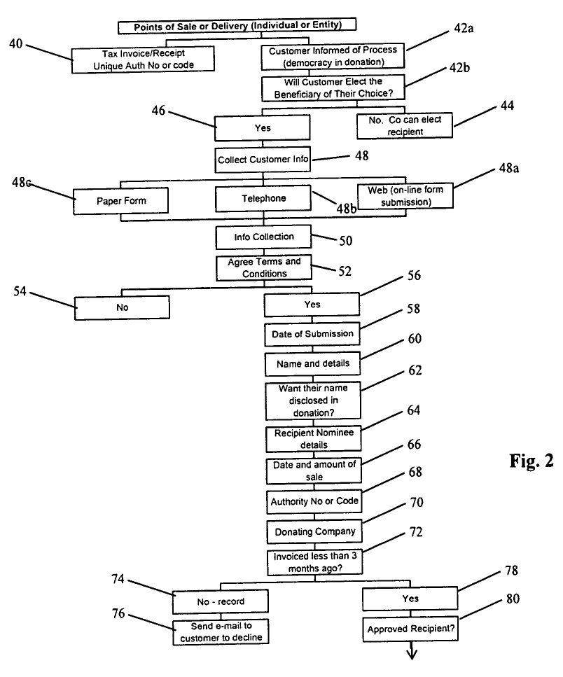

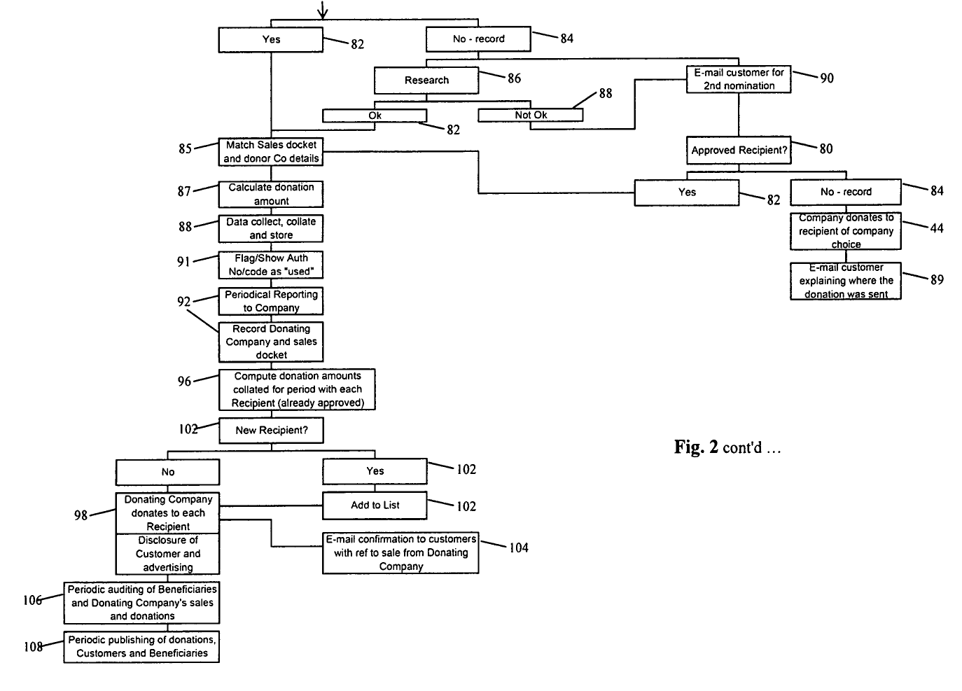

Use of the invention to allow democratic donations will now be discussed with reference to FIGS. 1 and 2.

The invention requires that business entities, such as retailers 14, each offer and promote that with a purchase from the retailer 14, an amount will be donated to a beneficiary that is a non-profit organisation. The amount will be based on the purchase. For example it could be a proportion of the sale price, a proportion of each good or service in the sale, an amount per sale or per good or service in the sale. The important connection is that the donation can be made as a result of having completed or entering into a purchase with a retailer.

The sale could be for a product or a service. The sale can be made in person, over the phone, by mail or online. In each case the customer 16 is issued by the retailer 14 a receipt, tax invoice or other record (either on paper or electronic) of the purchase that includes a unique code to be used by the invention to manage the democratic donations.

The retailers 14a, 14b and 14c and the administrator 18 of the democratic donations have a pre-existing relationship, such that the unique codes are communicated between the retailers 14 and the administrator 18. The server 20 of the administrator 18 may include storage means 22, such as a hard disk storing a database, that records the details of every retailer 14 registered to be part of the democratic donation system. Details include the full name, legal registration numbers, contact information and a description of the unique codes that the retailer 14 can issue to customers 16. For example, each unique code that can be created by the retailer 14a must start with the three characters “TRU” which could be an abbreviation of the store name followed by five digits. If the manner in which a donation amount is calculated for purchases from a particular retailer 14 can be different, information of the different methods for calculating the donation amount is also stored, If the choice of method is based upon the type or information collected about a purchase, information about this is also recorded.

Each retailer 14 typically utilises a computer system 24 to manage their accounts. This includes software to generate receipts, tax invoices or other record of a purchase for a customer. With this invention, software installed on the computer system 24 causes the records of a sale produced to contain a unique code. The unique code must be in the form defined by the administrator 18. The allocation of unique codes may be based on random number selection or may simply run sequentially. There are many known methods used in software programming to generate unique codes and most would be suitable for use here provided that a code is only ever used once on any record of sale produced by the retailer. Further, the software causes the record of sale to include the contact information of the administrator 18, such as a website or phone number.

Once the unique code is generated or selected and included in a record of sale, the retailer 24 must communicate that code (or an indication of the code) to the administrator 18 to indicate that the code can now be validly used by the customer 16. These codes may be communicated over the Internet 30, such that the server 24 generates and causes a message to be sent to the server 22 that includes the code, such as an e-mail message or special message having XML mark-up language according to a pre-defined message protocol previously agreed by the administrator 18 and retailer 14. The message may also be sent securely, such as using private and public keys.

The server 22 receives the messages sent by the retailers 14 that include an indication of the retailer 14 who sent the message, details of the purchase and the unique code of the purchase.

This information is then stored in the database 22, for example in a separate table in a relational database system and is related to the associated retailer's 14 information entry.

The customer 16 having the receipt 40 may now choose to use the unique code to choose which non-profit organisation will receive the donation associated with their purchase. This process will now be explained with reference to the flowchart of FIG. 2.

At this point, the method of the invention can be implemented in order to allow the customer a choice of electing a beneficiary of any donation component of their purchase price. The component of the purchase price may be a proportion of whole or part of the sale, or a set amount per sale or per item within the sale.

The method of allowing a customer to select a non-profit entity to receive a donation associated with their purchase from the retailer will now be described with reference to FIG. 2. In this example, the administrator 18 and the customer interact over the Internet using a website that is controlled by the administrator 18. In this example, the website is hosted by the administrator 18 on their computer system 20, however the website could easily be hosted by a third party 26 and the required information communicated to the server 20 for processing.

In this example, the record of sale contains both a unique code 40 and a website address. Using their Internet enabled device 28a, such as a personal computer, the customer 16a is able access the administrator's 18 website using the website address. Once the customer 16a accesses the website, the website informs them of the process of democratic donations 42a and asks the user whether they wish to choose the non-profit organisation 42b to receive the donation associated with the unique code.

The customer may choose “no” 44 in which case the administrator 18 or retailer 14a that issued the unique code can select the beneficiary. This donation will then be processed as later described below.

Alternatively, the customer 16a may select “yes” 46 in which case they are presented with a new webpage that requests the customer 16a to enter in their customer information 48. While this has been described as used with a webpage 48a, the information can also be collected over the phone 48b or using a paper form 48c. The information now collected 50 the customer 16a is asked whether they agree with the terms and conditions of the democratic donating process 52. This may be a tick box on the website or paper form; or a question asked over the phone. If the customer 16a selects “no” 54 then the process ends here. Alternatively, the administrator 18 or merchant 14a may choose the beneficiary 44 and the processing of the donation continues as described later below.

If the customer 16a selects “yes” 56 then the following information is captured:
The current date 58
The customer's 16a name and details 60
Whether they would like their name disclosed to the beneficiary 62
Details of the beneficiary 64. The customer 16a may be asked to choose from a list of beneficiaries that have already been determined to be suitable. They may be presented to the customer in the form of a pick list, where the beneficiaries included in the pick list are constantly reviewed and revised. Alternatively, the customer 16a may be given no selection choice at all and instead asked to enter the beneficiaries name into a text box. As a further alternative, the customer 16a can choose by ticking a tick box that the retailer 14a or administrator 18a choose the beneficiary.
Details of the purchase associated with the unique code 66
The unique code on the record of purchase 68
The name of the company that will give the donation, in this case the retailer 14a that issued the record of purchase 70

In one embodiment, the customer 16a will manually provide 58, 60, 62, 64, and 68 via online form. The administrator 18 can then automatically cross check things like 68, 66 and 70 because they are already known.

Alternatively, 66 and 70 may also be manually input by the customer 16a to assist in verification.

Yet, in a further embodiment where a business to business transaction exists (or a regular store card transaction), the retailer and customer may pre-arrange for all sales of a certain type or time frame to trigger an automatic donation to a pre-set beneficiary. In this case it is possible for 58, 60, 62, 64, 68, 66 & 70 to all be known and for the system to 100% automatically deliver the outcome.

This information is communicated to the server 20 over the Internet 30 and is stored 22 for processing by the server 20.

First, the information is processed to determine whether the record of purchase is too old to be used in the system. In this case, it is checked whether the record of purchase is more than three months old 72. If it is more than three months old 74 then processing of the donation stops and the customer 16a is informed 76 of the reason why, such as through an automatic e-mail message.

If it is determined that the record of purchase is not too old 78, the server now operates to determine whether the requested beneficiary is a suitable non-profit organisation to receive the donation 80. The database 22 stores a list of pre-approved beneficiaries. The requested beneficiary is compared to those in the database 22 and if a match is found the beneficiary is considered approved.

If there is no match 84, the administrator 18 undertakes research 86 to determine whether the requested beneficiary, while not pre-approved, is suitable. If the requested beneficiary is not suitable 88 then an automatic e-mail is sent 90 to the customer informing them of the determination and asking them to select another beneficiary. The new requested beneficiary is again assessed for suitability and if the new beneficiary is found to be unsuitable, step 90 could be repeated. Otherwise, the administrator 18 or retailer 14a can simply choose 44 and an e-mail is then sent to the customer 16a notifying them of this 89.

Once a requested beneficiary is approved 82 then the sever cross-matches 85 the details of the purchase entered by the customer 16a at 66, 68 and 70 with those already received from the retailer 16a. This may be performed automatically. The comparison may be made on the unique code as the key, then other details such as retailer name and total sale price may be cross-matched to ensure validity.

The server 20 then calculates 87 the donation amount. The calculation method may be common to all purchases from the retailer 24a, or different based on purchase type or purchase amount. The server 20 determines the correct method as stored in association with the retailer 14a in the database 20 and applies it. Alternatively, an indication of the correct method may be included as part of the unique code.

The server 20 then creates a new entry 88 in the database 22 to record that the calculated donation amount must be paid to the requested beneficiary. These records will later be used in consolidation.

Then, the record of the purchase in the database is marked as used 91 so that it can not be used as a match for further donation requests.

At periodic intervals, say monthly, the server 20 generates 92 a report and sends it to the retailer 14 based on the entries 88. The report outlines which unique codes were received from their customers 16, the amount of each donation and a summary of where those donations are made and various totals. This can be sent to the retailer 14 by e-mail.

Entries 88 are also used at periodic intervals, say monthly, to calculate the total amount payable to each beneficiary 96. The total for each beneficiary for a retailer 14 is sent to the retailer for payment by them 98.

Alternatively the administrator 18 may arrange for a cheque to be printed (or direct electronic transfer to be made) by the retailer 14 or retailer's bank of the donation amount to be sent to the beneficiary. This could be done by sending an electronic report with a signal to the retailer to commence payment. In this way the donations can automatically be made via cheque or direct electronic transfer.

If the beneficiary is new to the system, they are added to the list of suitable beneficiaries 102.

If requested by the customers 16, an automatic e-mail notification can be sent 104 to them indicating that their democracy donation has now been paid to the relevant beneficiary.

The records held by the administrator 18 can be used for auditing 106 the payments made by retailers by checking with the beneficiaries and for periodically publishing summaries of donations that were paid using the system 108. This summary is then made available of the website.

It will be appreciated by persons skilled in the art that numerous variations and/or modifications may be made to the invention as shown in the specific embodiments without departing from the spirit or scope of the invention as broadly described.

For example, any of the communication steps could be performed without using the Internet. Other forms of communication could be used such as telephone calls with automatic voice prompts where the dialed numbers are automatically stored into the database 22. Information can be collected and entered by the administrator 18 into the database 22 from paper forms sent by postal mail.

The database may be designed in anyway provided it is able to store the information discussed above and can be queried to produce the determinations and calculations required in order to perform the method of the invention.

The retailer 16a and the administrator 18 may in fact be the same entity. In this case, the computer systems 24a and 20 would be combined.

The business entity includes partnerships, trusts, companies, associations or individuals that are able to produce a record of sale that includes a unique code as described above.

The retailer 16a may in fact be a wholesaler.

Further data could be stored in the computer system, such as beneficiary tax-deductibility status, banking details, account passwords, next audit date and different donation rates for different donating entities.

The beneficiary may include non-profit organisations such as registered charities, local schools, community and sports groups, associations, churches and other environmental and charitable organisations.

Also, totals payable by a business entity may be the total payable by multiple business entities that are related.

The present embodiments are, therefore, to be considered in all respects as illustrative and not restrictive.

The claims defining the invention are as follows:

1. A method of managing donations, wherein the method comprises the steps of:
receiving and storing information on a plurality of purchases from a business entity, wherein each purchase has an associated donation;
receiving information of purchases made from the business entity by customers and an indication of a beneficiary that the associated donation should be paid to;
cross-matching the information on purchases made from business entities and information on purchases made by customers;
if a match is found for a purchase, adding the donation associated with the purchase to the total donation amount to be paid to that beneficiary by the business entity;
sending to the business entity the total donation amount to be paid to each beneficiary by the business entity.

2. A method of claim 1, wherein the purchase is a retail purchase of a good or service.

3. A method according to claim 1, wherein the associated donation is based on the total price of the purchase or based on one or more of the items included in the purchase.

4. A method according to claim 1, wherein the method further comprises the step of determining the amount of the donation associated with the purchase.

5. A method according to claim 1, wherein if a match is found the method further comprises storing an indication that the matched purchase can not be used in any other cross-matching steps.

6. A method according to claim 1, wherein the step of receiving information on purchases made by customers comprises receiving the information as entered into on a website.

7. A method according to claim 1, wherein the method further comprises the step of determining whether the beneficiary that the donation is to be paid to is a suitable non-profit organisation.

8. A method according to claim 1, wherein the method further comprises the step of resetting the total donation amount to be paid to all beneficiaries by the business entity at a predetermined time interval.

9. A method according to claim 1, wherein the step of sending the business entity the total donation amount is only performed at a predetermined time interval.

10. A method according to claim 1, wherein the method further comprises receiving and storing details of the customer, and sending this information to the business entity together with the total donation amount to be paid or to the beneficiary to which the associated donation is to be paid.

11. A method according to claim 1, wherein the beneficiary is a non-profit organisation.

12. A computer system to manage donations, computer system comprising:
a purchase storage means to store information on a plurality of purchases from a business entity, wherein each purchase has an associated donation; and information of purchases made from the business entity by customers and an indication of the beneficiary that the associated donation should be paid to;
a processor to cross-match the information on purchases from a business entity and purchases made by customers, and if a match is found for a purchase, the processor operates to add the donation associated with the purchase to the total donation amount to be paid to that beneficiary by the business entity.

13. A computer system according to claim 12, wherein the processor further operates to determine the total donation amount to be paid to each beneficiary by the business entity.

14. A computer system according to claim 12, wherein the computer system is connected to the Internet.

15. A computer system according to claim 12, wherein the computer system further comprises a communication port to send to the business entity the total donation amount to be paid to each beneficiary by the business entity.

16. A computer system according to claim 12, wherein the computer system comprises a further communication port to receive the information about the purchases.

17. A computer system according to claim 16, wherein information on one or more purchases is received from the entry of information into a website

18. A computer system according to claim 12, wherein the purchase is a retail purchase of a good or service.

19. A computer system according to claim 12, wherein the associated donation is based on the total price of the purchase or based on one or more of the items included in the purchase.

20. A computer system according to claim 12, wherein the processor further operates to determine the amount of the donation associated with the purchase.

21. A computer system according to claim 12, wherein if a match is found the processor further operates to store on the purchase storage means an indication that the matched purchase can not be used in any other cross-match processing.

22. A computer system according to claim 12, wherein the computer system further comprises a beneficiary storage means to store information on suitable beneficiaries and the processor operates to determine whether the beneficiary that the associated donation should be paid to is stored in the beneficiary storage means.

23. A computer system according to claim 12, wherein at predetermined time intervals the processor operates to reset the total donation amount to be paid to all beneficiaries by the business entity.

24. A computer system according to claim 12, wherein the processor further operates to determine the total donation amount to be paid to each beneficiary by the business entity at a predetermined time interval.

25. A computer system according to claim 12, wherein the purchase storage means also stores the details of the customer, and the processor further operates to send customer details to the business entity together with the total donation amount to be paid or to the beneficiary to which the associated donation is to be paid.

26. A computer system according to claim 12, wherein the beneficiary is a non-profit organisation.

27. Software, that when stored on a computer readable storage means medium of a computer causes the computer to operate in accordance with the method of claim 1.
